(19) United States
(12) Patent Application Publication
(10) Pub. No.: US 2013/0166396 A1
(43) Pub. Date: Jun. 27, 2013

(54) PROCESS AND SYSTEM FOR ADOPTION OF A MATERIAL OBJECT OFFERED ON AN INFORMATION NETWORK

(71) Applicant: Olivier Acher, Gif-Sur-Yvette (FR)

(72) Inventor: Olivier Acher, Gif-Sur-Yvette (FR)

(73) Assignee: HORIBA JOBIN YVON SAS, Longjumeau (FR)

(21) Appl. No.: 13/336,546

(22) Filed: Dec. 23, 2011

(51) Int. Cl. G06Q 30/02

(52) U.S. Cl. 705/14.73

(57) ABSTRACT

A process and a system giving to material objects in the form of samples an equivalent to the peer-review and publication of articles includes one embodiment where the review and publication is given by the fact that a third party, called a user, from the public who may be interested by the material object, has requested and received the material object under specific contracting conditions. Thus, this process may be generally called adoption, or more specifically peer-adoption or user-adoption of the material object.

### TECHNICAL FIELD

The current invention is related to a process and a system for the peer-adoption or user-adoption of a material object which is offered on an information network. It is more particularly dedicated to the scientific field in which material objects in the form of samples issued from research and development are to be used by third parties for making further research and development.

### BACKGROUND

In the scientific field, scientific journals require that scientific articles, before their publication, are reviewed by people called peers. The peers can either accept or refuse the publication of the submitted papers. Such process is called “peer review” of the article. Acceptance or refusal is decided by the reviewer on several factors including: the interest of the work for the community; and the scientific quality of the content, for example.

The publication process is a well-defined procedure which has been somewhat standardized. For example, the dates of the steps toward the publication have been defined as submission date and publication date, and all scientific articles have their author list and author affiliation included in the article. As another example, the published scientific articles can be cited according to well-accepted formats. The publication process plays a major role in scientific knowledge dissemination, which is a major task assigned to academic science and scientists. As such, scientific articles are the basis of metrics commonly used for quantifying the production of individuals and organizations involved in science.

Research and development individuals or staff are not only producing scientific articles but they also often produce material objects in form of samples, for example a sample of an electronic integrated circuit, a sample of an alloy, a sample of a chemical entity or compound, or other.

In such a case, if the article related to the material object may be reviewed and published under a peer review process, there is no such procedure for peer review of the sample. Nevertheless, it would be of great interest to facilitate the circulation of samples between different research groups, as a contribution to scientific knowledge dissemination, and to include this form of contribution of individuals and organization to the scientific dissemination, in the metrics commonly used for quantifying their contribution to science. For that purpose, it would be of great interest to have some kind of a “peer-review” and publication for a sample.

### SUMMARY

The invention is thus related to a process and a system giving to material objects in the form of samples an equivalent to the peer-review and publication of articles.

In its simplest embodiment, the review and publication is given by the fact that a third party, called a user, from the public who may be interested by the material object, has requested and received the material object under specific contracting conditions. Thus, this process may be generally called adoption, or more specifically peer-adoption or user-adoption of the material object.

In addition, this invention involves a large public as an offer of the material object is made on an information network which has a large public access even if the dissemination of material objects may be limited to a specific subset or group, such as scientists who have already made an article publication; or members of a given scientific or professional society.

In addition, the offer is not restricted to a sale of the material object but may be any kind of contract which is not against the law, i.e. for free, for borrowing, exchange, collaboration, etc. The proposed process and system can also be configured to handle those contracting conditions.

In addition, as the material object which is a sample is associated with a sample poster to which is assigned an identification reference when published, with the same reference format as a conventional scientific publication, it is possible to keep track of its citations in the literature or on computer networks to have also a good indicator of its value, and to attach appropriate credits to the authors and providers of the sample.

In a most advanced embodiment, the process is organized so that a transaction occurs only if the user and the provider consider themselves as “peers”, i.e. people deserving credit in their scientific field. In contrast with known methods for selecting “peers”, which is commonly done through the human expertise of a senior scientist, this is achieved as a result of the following method: The would-be user of the sample is made aware that he has to pay some amount of money in order to get the sample. In this way, the would-be user is inclined to adopt the sample only if he gets a credible indication that this sample is of significant scientific interest. This is through the description of the sample provided in the sample posting or description, or through any way to evaluate the scientific merits and reputation of the sample provider. This money or most of this money, does not go to the sample provider, but goes to the provider of the service who is called the publisher. They are denominated “publication fees”. So these publication fees contribute to the fact that the requester only asks for samples from a scientific “peer”. In return, the sample provider is encouraged to give away his sample for free or almost free only to people who will use his sample for an acknowledgeable advancement of science, otherwise there are limited reasons for him to give away his sample. Among the acknowledgeable advancement of science the provider may have in mind, there is: the user issues a publication in a regular peer-reviewed journal, with appropriate citation to the provider's sample and other provider's scientific articles. In other words, the sample provider is incited to give away his sample to the requester of the sample only if he considers him as a scientific “peer”.

The process in which the requester has to pay significant fees to get the sample, and the provider receives no or a limited amount of these fees, can be termed “peer-adoption process”. The sample poster published on a Second network can be termed “peer-adopted” publication. In this peer-adoption process, the requester or user of the sample is also asked by the publisher to act as a “referee” of the sample poster before it gets published, by requiring or suggesting to the provider appropriate clarifications, or improvement, of the Sample Poster before publication. The requester is expected to be motivated in requesting some improvements of the sample poster, since it is a good way to begin a fruitful relation with the provider to make constructive suggestions of improvements to his communication; and the provider is also expected to be motivated in accepting to provide the improvements asked by such a referee, because benevolent advices from a peer to improve his communication are useful to him.

In the case the sample provider requests a significant payment for the sample, the condition usually required for a valid peer-review that the provider and the requester have no related money interest breaks. Indeed, one may suspect that the provider may accept sample requests from requester that he does not consider like scientific peers, but simply as clients. Under that respect, it is important to know that in recent years, scientists are asked not only to produce scientific-grade results that can only be judged by peers, but also useful outcomes to a broader community. Under that respect, the ability to sell some scientific samples is a proof that the samples are perceived as useful by some users. This process can be termed “user-adoption”. In such a situation, the publication of the sample poster as a result of the user request for the sample therefore is the proof not of the scientific validity of this sample poster, it is the proof that users perceived some interest for this sample. This process can be termed “user-adoption” process.

A collection of scientific articles that have been published exclusively through a “peer-adoption” process is therefore a peer-validated source of information on sample dissemination for scientific purposes

A collection of sample posters that have been published exclusively as a result of “user-adoption” process is therefore an non peer-validated source of information on sample dissemination for a broad variety of uses.

More precisely the invention is related to a process for the peer or user adoption of a material object wherein the material object in the form of a sample having been produced by a provider, a description of the material object having been prepared in the form of a publishable poster by said provider, an offer of the sample to the public, associated with the poster, being made on a first information network, the first information network being preferably the WEB, the offer and the poster of sample being part of a first information domain, a means for receiving requests for sample from the members of the public being implemented, and in that, when a request for sample is received from a members of the public and said request is accepted by the provider, the member being then called a user:
the content of the poster related to the sample is published on a second information network and is given an identification reference, the second information network being preferably the WEB, the published poster for the sample and its identification reference being part of a second information domain,
the identification reference of the poster serving as an identification reference to the sample,

In various embodiments of the invention, the following means, possibly combined in any technical way, are also considered:
the content of the poster related to the sample is published on the second information network with the same form as a scientific article, and is given an identification reference according to the current scientific practice,
the sample provider is the sole author of the poster published on the second information network,
the sample provider is one of the authors of the poster published on the second information network,
the other author(s) of the poster published on the second information network is/are the requester(s)/would-be user(s),
after publication in the second information domain, the published poster is not modifiable,
after its publication in the second information domain, the poster of the offer on the first information network is not modifiable in case it is kept in the first information domain for further sample offer,
the publication of the poster in the second information domain is done only after the user has paid for the publication,
the publication of the poster in the second information domain is done only after the user confirms he has received the sample,
the publication of the poster includes the date when the poster and the related offer have been made on the first information network,
the publication of the poster includes the date when the request has been accepted by the provider,
the publication of the poster includes the date when the user confirms he has received the sample,
this is for the first accepted request for a given sample that the identification reference is assigned and the poster is published,
this is when first user has paid for the publication for the first accepted request for a given sample that the identification reference is assigned and the poster is published,
this is when the user confirms reception of the sample for the first accepted request for a given sample that the identification reference is assigned and the poster is published,
the sample is sent/given access to the user only after the user has paid for the publication,
the sample is sent/given access to the first or following users only after each user has paid for its publication, the identification reference being assigned and the poster published at the first publication and counter(s) related to this first publication being incremented for following publications of a given sample,
the sample has been produced during a research and/or development phase,
the first information domain is called “market place”,
the second information domain is generically called “Journal”, “Proceeding”, or “Bulletin”,
in case the adoption of the sample is a peer-adoption, the second information domain is called “peer-adoption Journal”, “peer-adoption Proceeding”, or “peer-adoption Bulletin”,
in case the adoption of the sample is a user-adoption, the second information domain is called “user-adoption Journal”, “user-adoption Proceeding”, or “user-adoption Bulletin”,
before the offer is made, the poster is checked by a moderator in order that it is publishable and in case it is not publishable, the provider is requested to do corrections till publishable or the offer is not made,
before the offer is made, the sample is checked by a moderator in order that it is publishable and in case it is not publishable, the provider is requested to do corrections till publishable or the offer is not made,
the moderator is a team,
the moderator is the publisher,
the offer is not made in case the sample is contrary to the law,
the offer is not made in case it is contrary to the law,
during the checking of the sample and poster, all versions of the poster are date stamped and previous versions are kept,
the offer of the sample from the sample provider is for free in order to have a peer-adoption process,
under peer-adoption process, the user may have to pay the cost of handling and shipping for receiving the sample,
before the publication of the poster, the offer may be modified by revised version of the sample and/or publishable revised version of the poster, and before the offer is made, the revised version of the sample and the revised version of the poster are checked by a moderator in order that they are publishable and in case they are not publishable, the provider is requested to do corrections till publishable or the offer is not made,
the offer is kept in the first information domain even after the publication in the second information domain in case the provider decides so,
before the publication of the poster, the requester/would-be user may suggest or request clarifications, or improvements, in the sample poster description, as part of the negotiation process resulting in an accepted offer and a published sample poster,
when a request is received and accepted for a revised version of a sample, a new identification reference is given to the revised version of the sample and the content of the poster related to the sample, possibly a revised version of the poster, is published on the second information network with the new identification reference of the sample and the date of the publication, the information network being preferably the WEB,
a sample and a revised version of a sample have different identification references,
the first information network is the same as the second information network and both information networks are the WEB,
the first information network is different from the second information network,
the first information network, the one for the offer, is the WEB,
the second information network, the one for the publication, is the WEB,
the public is essentially the scientific community involved in research and development,
the offer is reserved to the scientific community involved in research and development,
The user has to pay publications fees for the publication in the second information domain thereby establishing that all publications in this second information domain correspond to a significant interest from the user,
The user has to pay publications fees for the publication in the second information domain, but the offer is made without any money counterpart for the provider, so that the only benefits that the provider can expect from giving away his sample are related to the advancement of science and increase of his scientific reputation; this serves as an incentive for the provider to accept requests only from people who will provide credible indication that they will use the sample in order to obtain significant scientific achievement; in other words, this will assess that the sample provider considers the sample adopter as a “peer”,
The offer is made with a money counterpart that is a small fraction of the cost for obtaining the sample, which makes evident that the request acceptance by the provider is accepted because of the scientific credibility of the requester according to the provider's standards, which again designates the sample adopter as a “peer” of the provider; the publication of the sample poster and the issuing of an identification reference being therefore a peer-adoption process,
the price to pay for the sample, excluding the cost of the publication that the publisher receives, is set by an auction process regarding the offer,
The second information domain contains publications related to samples that have been adopted through “user-adoption” process; and the publications are done in a “user-adoption journal” or “user-adoption proceeding” or “user-adoption bulletin”,
The second information domain contains publications related to samples that have been adopted through “peer-adoption” process; and the publications are done in a “peer-adoption journal” or “peer-adoption proceeding” or “peer-adoption bulletin”,
accesses to the offers on the first information network are limited by access rights,
access rights are given by registration,
the offer is selected from: for free, a sell, a borrowing, an exchange, collaboration in research and development or any other not illicit contract,
a counter is associated to each identification reference of a sample and published with it and said counter is incremented each time a request for the related sample is accepted by the provider,
a counter is associated to each Author and co-author of the Sample Poster, corresponding to the number of Sample Reference that he authored or co-authored on the second information network; this counter being visible for each sample provider on the first information network in order to provide relevant indications on the importance of this provider as a sample provider,
a counter “number of citing publication” is obtained as the sum of the number of citing articles for a given set of sample reference (for example associated to all the sample references authored or co-authored by a given person); this counter is calculated using information on the second network, and provided to the first network, as a relevant indication of the importance of this set of sample to the scientific community,
the identification reference is a Digital Object Identifier,
process in which a number of same sample are offered,
process in which different samples are offered,
the offer is related to a contract and said contract is processed between the provider and the user through the first information network.

The invention is also related to a system for the peer or user adoption of a material object, characterized in that it is configured to operate according to the described process with computing means configured to do the following actions on an information network:
to receive from a provider a description of the material object prepared in the form of a publishable poster by said provider, the material object in the form of a sample having been produced during a research and/or development phase by the provider,
to make an offer of the sample to the public with a publication of the poster on a first information network, the first information network being preferably the WEB, the offer and the poster of sample being part of a first information domain,
to receive requests for sample from members of the public, and
when a request is received from a member of the public and accepted by the provider for a sample:
to publish the content of the poster related to the sample on a second information network, and to give an identification reference, the second information network being preferably the WEB, the published poster for the sample and its identification reference being part of a second information domain,
to use the identification reference of the poster as an identification reference to the sample.

The system is under the control and supervision of a publisher which owns a publisher system for executing the process of the invention.

### BRIEF DESCRIPTION OF THE DRAWINGS

FIG. 1 is a workflow diagram of the operations of a publisher system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

An example of implementation of the core of the invention is now described and possible variations are also presented.

The process in which the user of a material object in the form of a sample is the adopter of said sample starts on the side of a “provider” who has produced a sample in a research and development activity and who wants to offer said sample to the public.

The meaning of material object in the form of a sample has to be taken broadly. This can be one unique material object or multiple material objects of the same kind It can be, for example, an apparatus, a component, a chemical compound, the authorization to use apparatus or animals of a laboratory and so on. The material object can be an existing object or an object which is produced on purpose such as, for example, particles of a beam accelerator or radioactive elements of short period.

The offer is intended for providing the sample for studies in a research and development activity and, as a consequence, the public to which the offer is made and directed is the scientific community. In order the sample is correctly distributed, only members of the scientific community and who has published a scientific article can receive the sample or get access to it. The member of the public who is finally authorized to get the sample or to have access to it is called the “user”. The system is operational for multiple users of a given sample, the sample being a unique object (serial users in time) or multiple identical objects (possibly parallel users in time).

The offer is, most of the time, a free offer except that, in the preferred implementation, the user pays for the publication. However, the offer may be any kind of operation which is not unlawful such as, for example, a sell, borrowing of the sample, leasing, an exchange, collaboration in research and development, access to the sample and possibly a laboratory . . .

The offer is associated to a contract between the provider and the person who will receive/have access to the sample and who is called a user when the provider has accepted his request for the sample. Before the provider has accepted the request for the sample, the person interested by the sample is called a requester or would-be user. The contract may be conditional to obligations to the parties such as a payment, supply of information or tools, obligation for the user to mention the common identification reference of the poster and sample in any scientific publication and presentation, use of sample according to good practices in the scientific community . . .

In addition, a contract is also made between the provider and the entity who is managing the system allowing this peer or user adoption of sample. The entity who is managing the system allowing this peer or user adoption of sample is called the “publisher” and he owns a “publisher system” configured to operate for peer or user adoption of sample.

In addition to the production of a sample, the provider must prepare a poster containing information about the sample. This poster has the same format as a peer-reviewed scientific publication, it contains at least a title, a list of one or more authors, their affiliations, the corresponding author being the sample provider; an abstract; references to other scientific articles (at least one); and a text body and he must also prepare information about the offer which is the type of contract/conditions for getting/accessing the sample. The publisher system has default contract for helping the provider. The publisher system may manage the contract definition according to provider and requester/would-be user requirements if this/those last one(s) do(es) not want to manage this part of the process. This poster and the offer should be publishable in a first information domain which is called “market place” on a first information network, preferably the WEB. This market place is typically an INTERNET site managed by the publisher with his publisher system.

The meaning publishable relates to formal and ground obligations such as for example understandability, clarity, minimum of information, structure, useable support of information for the information network, legality . . .

When considered appropriate to be posted on the market place, the offer and poster are made available to the public on the market place.

Those operations related to the market place domain and the possible publication of the poster in the second information domain may be paid by the provider either by a fixed fee or by regular fees or a mix of the two, as long the publication of the poster is accessible for example. In other preferred implementations, the operations related to the market place are free for the provider and this is the user who get/have access to the sample who pays for all the operations related to the market place domain and the ones related to the publication in the second information domain. However, extra operations in the market place domain such as contract definition by the publisher may be paid by the provider. It has to be noted that the publication of the sample poster with its identification reference is done only the first time a request from a user is accepted by the provider (preferably when the user has received the sample) and this means that this is the first who gets/have access to the sample who pays. In other embodiments, further users should also pay, the related further publications corresponding to the incrementation of counter(s) in the second information domain related to the published poster of the sample (and possibly of counter(s) in the first information domain if the offer is kept there). Automatic means for handling the payments are preferably implemented in the system.

Once the publisher has accepted the poster and an offer is made on the market place, in other words that the publisher has made the offer on the first information network, the sample and offer are accessible to the public who may request the sample.

Means for receiving requests for sample from requesters/would-be users are implemented in the publisher system and the requests are received by the publisher who redirects them to the provider. This is a way for the publisher to keep track of requests even if he is not directly involved in the process leading to acceptance or refusal of the request by the provider. Preferably, all exchanges between the provider and the would-be user (potential user) are made through the system of the publisher.

In a less preferred embodiment, the request is directly sent to the provider by the would-be user, the publisher handling not the request.

When the provider has accepted the request and the contracting conditions are meet between the provider and the user, the publisher system is informed and the sample is transferred/given access to the user by the provider. Once the provider and the requester have agreed about their obligations, corresponding discussions and exchanges being preferably done through publisher means, the publisher provides to the parties the corresponding agreement with a proofable content and date. When the user has paid at least for the publication, the publisher asks the provider to provide the sample. Preferably, the publication on the second information network is done only after the user confirms he has received the sample, that is, after the user has paid the publisher for the publication (and possibly paid the provider in case this has been agreed between them)

Preferably, all exchanges between the parties related to the offer and request and contract fulfillment are kept secret except for related parties.

In all case, when the request is accepted by the provider and, preferably, after the user confirms he has received the sample, the publisher system assigns an identification reference which is unique to the poster which is published and, as a consequence, indirectly, this identification is a reference to the related sample. This identification reference is a Digital Object Identifier. The Digital Object Identifier is provided by the Digital Object Identifier (DOI®) System and it has been implemented for identifying content objects in the digital environment. The DOI System is an ISO International Standard and is managed by the International DOI Foundation. This DOI is unique for a given sample poster (for either one object or a plurality of same objects) and a new DOI is assigned in case the sample is revised because this is a new sample with new characteristics.

With this DOI, the publisher system publishes the poster related to the sample, with or preferably without the offer, in a “peer-adoption journal” of a second information domain which is accessible on an information network of the WEB type. This “peer-adoption journal” is typically accessible on an INTERNET site managed by the publisher.

Preferably, a counter is implemented in the second information domain for publication in the peer-adoption journal, counter which is incremented each time a new request has been accepted by the provider for the related sample, or, preferably, when the new user has received the sample. Another counter may be implemented for counting all the requests for a given DOI and thus a given sample.

The number of requests from requesters and/or of acceptances by the provider of the sample are also good indicators of the value of the sample.

Alternatively, a sample that is a clone or a companion-sample of a sample already published in the second information domain, also generates a publication with its own DOI in the second information domain when it is adopted by a user; the date of this publication being the date of the latter adoption; but the content of the paper being substantially a reference to the first publication in the second information domain; in the same form as the well-known “addendum” or “erratum” form which a well accepted form for scientific article.

All those publications operations in the peer-adoption journal are made according to standards used in scientific paper publications.

The publisher system can also make revised offer for same sample or for revised sample.

In the case the system operates in a user-adoption mode, a specific “user-adoption journal” is implemented in the second information domain.

It has to be understood that the system of the invention is dynamic in that the information available in the market place and in the second information domain evolve in relation to offers, requests, acceptances, etc. and, practically, the information available through those domains are related to numerous samples with different statutes:
unpublished statute when the sample is only offered and no acceptance of request for sample occurred, the related information is only in the market place information domain, and
published statute when the poster of the sample has been published in the peer/user-adoption journal in the second information domain.

More generally, the offer with the poster stays available in the market place as long as necessary and/or depending on provider, publisher desire, even after the published statute has been given to the sample. The published statute is given only one time to a given sample but may be given several times when dealing with clones, parents, or further evolution, of a given sample.

In a way similar to existing practices in marketplaces, the provider and the requester or user may provide appreciation and feed backs on their satisfaction about the transaction. These “reputation” features can be helpful to guide further transactions. It is evident that the requester will request samples only from people who provide credible indications that their samples meet the scientific standards, the requester considers the sample provider as a “peer”; so this process is indeed a “peer-adoption” process, where both provider and requester qualify the other party as a peer,

Each sample poster can be evaluated and amended in a way similar to a conventional scientific publication, this evaluation is done before the sample is published. One difference here is that the evaluation on the interest (which is a usual prerequisite to accept a scientific paper submitted in a scientific journal) is answered positively, when a user volunteers to receive the sample. Another important step in the process of acceptance of a scientific publication is the improvement of the text and figures of the poster as a result of suggestions and remarks by the referee. In our invention, it is the Sample requester or user who is such a referee that is encouraged to provide constructive remarks and suggestions to the sample provider, in order to improve the quality of the sample poster that is transformed into a publication in the second network. As a consequence, the sample requester or user may request modifications to the poster and sample before it is published. Once the poster and sample has been published, no more modification is allowed to the poster and sample. This means that, in case there are more than one sample and that the offer is kept on the first information network for other requesters/would-be users after the publication (first accepted sample distribution), those (new) requesters and the sample provider will be not be allowed to modify the poster except through an addendum or erratum process.

From another point of view, the process and system of the invention can also be described with reference to the market place domain or to the second information domain and its peer/user-adoption journal.

The peer-adoption journal and the user-adoption journal are two different domains and in case they are implemented in the publisher system, they are clearly distinct.

From the Market Place point of view, the following operations are implemented through the publisher system:

Transactions are available only to scientist by checking the persons who access the publisher system, for example by registration. The sample provider provides the Sample Poster which is a description of the Sample available for dissemination, using the conventional form of scientific texts and his/her expectations on the counter part (the public to whom the offer is directed) for the sample dissemination and which relates to the offer.

The publisher system displays samples currently open for dissemination in the form of poster and related offer for sample provided by the provider of the sample.

The publisher system processes the requests for Sample from would-be users.

The provider and would-be user find a mutual agreement on the request for the offer. In the course of the negotiation, the would-be user may ask clarification and precisions on the sample, that the provider may include in an update of the Sample Poster. In case of acceptance, the would-be user pays the price for the sample if it was a sample for sale and then gets the sample. He thus becomes a user.

In the preferred embodiment, the publisher system process payment from the user for the publication and when done, the second information domain with its peer/user-adoption journal takes on for further processing.

From the Second information domain with its peer/user-adoption journal point of view:

When the request is accepted and the sample is or can be received/accessed by the user, the publisher system assigns a DOI to the sample and publishes the Sample Poster associated to the related sample according to the rules of scientific publishing in the second information domain. Preferably, a published sample is kept without any limit of duration in the Second information domain and is available to the scientific community according to the peer/user-adoption journal rules. The published poster is given a publication unique identification, a DOI for scientific article, as currently done for paper publications.

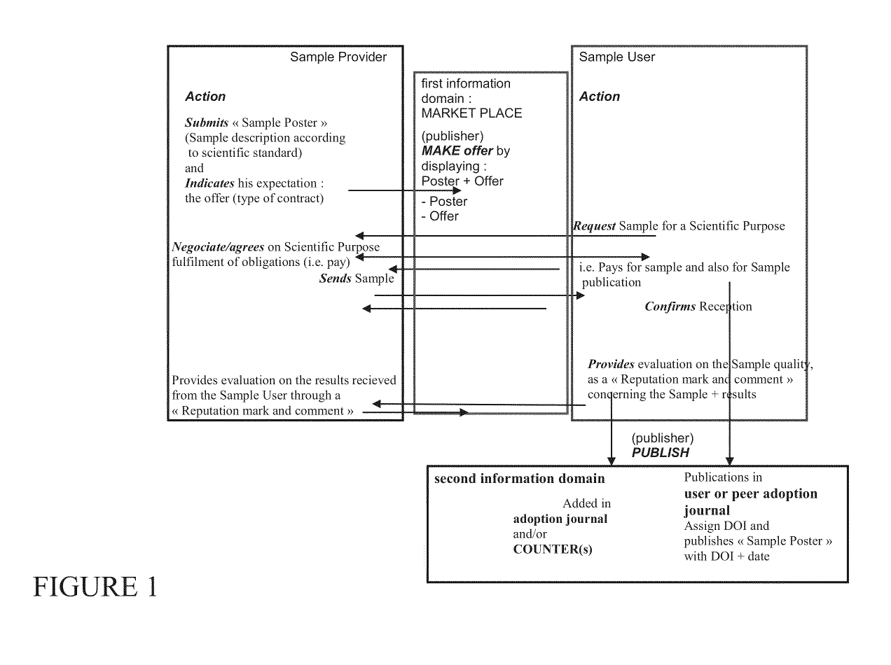

The process for the system is summarized by FIG. 1.

Again, due to the meaning of sample which can cover multiple identical objects, in the case of clone samples, that is samples which are practically identical, those samples are described by the same sample poster and the sample poster is published at the first dissemination (acceptance of the first request or, preferably, first received sample by first user). However, each time those clone samples are requested and the corresponding users have paid for the publications, new publications on the second information network are made preferably in the form of counter(s) incrementation. In various embodiments or alternatively, a counter of requests and/or a counter of accepted requests for samples and/or a counter of received samples by users is/are available with the (initial) publication on the second information network.

It has to be noted that the other information associated to the request, acceptance and related contract, such as terms and conditions, identity of the sample requester or user . . . , are not published in the second information domain since they are not scientific information.

Finally, a meter of the reputation of the sample provider is available in the second information domain by the quantity and quality of information available in this domain and more particularly to the number of added information and/or the counter of accepted requests for samples he provided.

In the case the sample is provided for free or almost free by the provider, and the user pays for the publication fees, then the publication acceptance process can be termed “peer-adoption”. This is because the validation that a sample is published with its poster comes from the fact that a scientist, the sample user, has paid to access the sample (by paying for the publication in the peer-adoption journal). This provides a YES answer to the question [symbol] is the sample something interesting and useful to the scientific community [symbol] , and a YES to the question [symbol] is the written description accurate enough so that a Scientist can opt for it [symbol] ; while the fact that the sample user is judged qualified enough by the sample provider who accepted the request for sample, while no money interest can bias his judgment, because he does not receive money and as a consequence his motivation is essentially science-oriented. The crossref infrastructure associated to DOI allows the publisher to retrieve the DOI of citing papers and this is also a metering possibility.

In the case the sample is provided against significant fees by the provider, then the provider may accept to transfer his sample even in the case he does not perceive the requester as a scientific peer. The neutrality conditions required for peer-evaluation are not met. Nevertheless, as it is commonly acknowledge that Scientific activity should provide some useful outcomes, the fact that the user is paying to access the sample is a proof that the corresponding scientific activity corresponds to something useful for some users. In that case, the publication acceptance process can be termed “user-adoption”.

Practically, the publisher system own at least one data base and a computer program for storing posters and the related offers and when conditions for making the offer on the market place are fulfilled, the offer is made by the publisher system in the first information domain. The program waits for a request to the offer and when a request is received, the provider of the sample is informed. Then the requester (would-be user) and the provider make exchanges through the publisher system to settle an agreement. When the provider accepts the requests and the conditions (i.e. payment of the publication and, possibly, for the sample) are fulfilled, and that the would-be user has paid for the publication, the publisher system assign a DOI to the poster and publish the poster in the peer or user-adoption journal in the second information domain. After the payment for the publication has been made by the user, the publisher asks the provider to send/give access to the sample to the user. The publication can be placed in a second data base or handled by the initial data base through the use of pointers and/or indirect addressing.

Preferably, the publisher system implements strategies to avoid leaks of provider and/or requesters by-passing the publisher system by keeping secret some information mandatory to parties by contract, for example conditions of use of the publisher system.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A process for a peer or user adoption of a material object, wherein
the material object in the form of a sample having been produced by a provider,
a description of the material object having been prepared in the form of a publishable poster by said provider,
an offer of the sample to the public, associated with the poster, being made on a first information network, the first information network being preferably the WEB, the offer and the poster of sample being part of a first information domain,
a means for receiving requests for sample from members of the public being implemented,
and in that, when a request for sample is received from a member of the public and said request is accepted by the provider, the member being then called a user:
the content of the poster related to the sample is published on a second information network, and is given an identification reference, the second information network being preferably the WEB, the published poster for the sample and its identification reference being part of a second information domain,
the identification reference of the poster serving as an identification reference to the sample.

2. The process according to claim 1, wherein before the offer is made, the poster is checked by a moderator in order that it is publishable and in case it is not publishable, the provider is requested to do corrections till publishable or the offer is not made.

3. The process according to claim 1, wherein the publication of the poster in the second information domain is done only after the user confirms he has received the sample.

4. The process according to claim 1, wherein when a request is received and accepted for a revised version of a sample, a new identification reference is given to the revised version of the sample and the content of the poster related to the sample, possibly a revised version of the poster, is published on the second information network with the new identification reference of the sample and the date of the publication, the information network being preferably the WEB,

5. The process according to claim 1, characterized in that the first information network is the same as the second information network and both information networks are the WEB.

6. The process according to claim 1, characterized in that the offer is selected from: for free, a sell, a borrowing, an exchange, collaboration in research and development or any other not illicit contract.

7. The process according to claim 1, characterized in that a counter is associated to each identification reference of a sample and published with it and in that said counter is incremented each time a request for the related sample is accepted by the provider.

8. The process according to claim 1, characterized in that the identification reference is a Digital Object Identifier.

9. The process according to claim 1, characterized in that the offer is related to a contract and said contract is processed between the provider and the user through the first information network.

10. A system for the peer or user adoption of a material object, comprising:
computing means configured to do the following actions on an information network:
to receive from a provider a description of the material object prepared in the form of a publishable poster by said provider, the material object in the form of a sample having been produced during a research and/or development phase by the provider,
to make an offer of the sample to the public with a publication of the poster on a first information network, the first information network being preferably the WEB, the offer and the poster of sample being part of a first information domain,
to receive requests for sample from members of the public, and
when a request is received from a member of the public and accepted by the provider for a sample:
to publish the content of the poster related to the sample on a second information network, and to give an identification reference, the second information network being preferably the WEB, the published poster for the sample and its identification reference being part of a second information domain, and
to use the identification reference of the poster as an identification reference to the sample.
